(19) United States
(12) Patent Application Publication
(10) Pub. No.: US 2011/0134526 A1
(43) Pub. Date: Jun. 9, 2011

(54) WATER-RESISTANT POLARIZING FILM, PROCESS FOR PRODUCING WATER-RESISTANT POLARIZING FILM, AND IMAGE DISPLAY DEVICE

(75) Inventors: Toru Umemoto, Osaka (JP); Sadahiro Nakanishi, Osaka (JP); Tadayuki Kameyama, Osaka (JP)

(73) Assignee: NITTO DENKO CORPORATION, Ibaraki-shi, Osaka (JP)

(21) Appl. No.: 13/058,094

(22) PCT Filed: Nov. 4, 2009
(86) PCT No.: PCT/JP2009/068788

§ 371 Date: Feb. 8, 2011

(30) Foreign Application Priority Data
Dec. 3, 2008 (JP) 2008-308126
Mar. 13, 2009 (JP) 2009-060390

(51) Int. Cl. G02B 5/30; B05D 5/06

(52) U.S. Cl. 359/491.01; 427/163.1

(57) ABSTRACT

A water-resistant polarizing film of the present invention contains an organic colorant having an anionic group and a non-cyclic compound having 2 to 5 nitrogen atoms. The non-cyclic compound is a linear aliphatic diamine or a salt thereof and more preferably an aliphatic diamine having 2 to 8 carbon atoms or a salt thereof. For example, the water-resistant polarizing film of the present invention can be produced by bringing a treating liquid containing the non-cyclic compound into contact with a single surface or both surfaces of a polarizing film containing the organic colorant.

### TECHNICAL FIELD

The present invention relates to a water-resistant polarizing film excellent in mechanical strength and optical properties, a process for producing the film, and an image display device.

### BACKGROUND ART

A polarizing film is an optical film having a function of transpiring a specific linearly polarized light from natural light or a polarized light. The polarizing film is used for, for example, a composition member of a liquid crystal display device, a lens for polarized sunglasses, and the like.

Hitherto, a polarizing film containing an organic colorant has been known. Furthermore, a water-resistant polarizing film containing an organic colorant is also known (Patent Document 1).

The water-resistant polarizing film in Patent Document 1 is made of an organic compound having 2 or more sulfonic acid groups, and 4,4′-tetramethyldiaminodiphenylmethane, 4,4′-dipyridyl, melamine or tetraaminopyrimidine.
Patent document 1: JP-A-11-21538

### SUMMARY OF INVENTION

However, the water-resistant polarizing film in Patent Document 1 has a problem of being low not only in mechanical strength but also poor in optical properties (such as transmittance and degree of polarization).

An object of the present invention is to provide a water-resistant polarizing film excellent in mechanical strength and optical properties, and a process for producing the film.

The present inventors have made eager investigations about a cause of a matter that the polarizing film in Patent Document 1 is poor in mechanical strength and optical properties. As a result, the present inventors have found out that the cause is use of a cyclic compound (the above-mentioned compound, that is, 4,4′-tetramethyldiaminodiphenylmethane, 4,4′-dipyridyl, or the like).

A water-resistant polarizing film of the present invention contains an organic colorant having an anionic group and a non-cyclic compound having 2 to 5 nitrogen atoms.

In a preferable water-resistant polarizing film of the present invention, the non-cyclic compound has 2 nitrogen atoms.

In a preferable water-resistant polarizing film of the present invention, the non-cyclic compound has 2 to 5 cationic groups each containing a nitrogen atom.

In a preferable water-resistant polarizing film of the present invention, the cationic groups are each an amino group or a salt thereof.

In a preferable water-resistant polarizing film of the present invention, the non-cyclic compound is a linear aliphatic diamine or a salt thereof, or a linear aliphatic ether diamine or a salt thereof.

In a preferable water-resistant polarizing film of the present invention, the non-cyclic compound is an aliphatic diamine having 2 to 8 carbon atoms or a salt thereof, or an aliphatic ether diamine having 2 to 8 carbon atoms or a salt thereof.

In a preferable water-resistant polarizing film of the present invention, the organic colorant has 2 or more anionic groups.

In another aspect of the present invention, a process for producing a water-resistant polarizing film is provided.

The process includes a step of bringing a treating liquid containing a non-cyclic compound having 2 to 5 nitrogen atoms into contact with a single surface or both surfaces of a polarizing film containing an organic colorant having an anionic group.

In a preferable water-resistant polarizing film of the present invention, the concentration of the non-cyclic compound in the treating liquid is 5 to 30% by mass.

In another aspect of the present invention, an image display device is provided.

The image display device has any one of the water-resistant polarizing films as described above.

The water-resistant polarizing film of the present invention is not easily corroded by water, and is further excellent in mechanical strength and optical properties.

When this water-resistant polarizing film is integrated into, for example, an image display device, the image display device provided can be a device excellent in endurance and high in display performance.

According to the process for producing the present invention, a water-resistant polarizing film excellent in mechanical strength and optical properties can be obtained by simple treatment of bringing a treating liquid into contact with a single surface or both surfaces of a polarizing film.

### DESCRIPTION OF EMBODIMENTS

A water-resistant polarizing film of the present invention contains an organic colorant having an anionic group and a non-cyclic compound having 2 to 5 nitrogen atoms.

A process for producing a water-resistant polarizing film of the present invention at least includes a step of bringing a treating liquid containing a non-cyclic compound having 2 to 5 nitrogen atoms into contact with a single surface or both surfaces of a polarizing film containing an organic colorant having an anionic group. In this step, the non-cyclic compound is crosslinked with the organic colorant so that the non-cyclic compound enters the inside of the polarizing film. When the non-cyclic compound is crosslinked with the organic colorant, a water-resistant polarizing film excellent in mechanical strength and optical properties (such as transmittance and the degree of polarization) can be obtained.

Hereinafter, the water-resistant polarizing film of the present invention and the process for producing the film will be specifically described.

In the present specification, a matter that a treating liquid containing a non-cyclic compound having 2 to 5 nitrogen atoms is brought into contact with a polarizing film may be referred to as “water-resisting treatment”.

In the present specification, the expression “A to B” means “A or more and B or less”.

### [Water-Resistant Polarizing Film]

### (Organic Colorant Having an Anionic Group)

The organic colorant contained in the polarizing film, which has an anionic group, is not particularly limited as far as the colorant is an organic compound exhibiting absorption dichroism.

The anionic group has a fixed anionic group bonded to the skeleton of the organic colorant. Usually, a counter ion is bonded to the fixed anionic group.

A partial amount or the total amount of the counter ion is substituted with cationic species of a non-cyclic compound having 2 to 5 nitrogen atoms.

Examples of the anionic group include a sulfonic acid group, a carboxyl group, a phosphate group, a salt thereof, and the like. The anionic group is preferably a sulfonic acid group or a sulfonate, and more preferably a sulfonate (—SO₃M group).

The number (substitution number) of the anionic group of the organic colorant is not particularly limited, and is preferably 2 or more, more preferably 2 to 5, and further preferably 2 to 4.

An organic colorant having 2 or more anionic groups is high in affinity with any aqueous solvent. Therefore, the organic colorant can be dissolved in an aqueous solvent, so that a good coating liquid can easily be prepared. By use of this coating liquid, a polarizing film can be obtained.

When the polarizing film is subjected to water-resisting treatment, the 2 or more anionic groups are combined with the non-cyclic compound to constitute crosslinking points.

The organic colorant is a compound which can form a polarizing film exhibiting absorptive dichroism.

The polarizing film is an optical film having a function of transpiring a specific linearly polarized light from natural light or a polarized light.

Examples of the organic colorant include compounds described in JP-A-2007-126628, JP-A-2006-323377, and the like.

When the organic colorant has 2 or more anionic groups, it is preferred that the individual anionic groups are not adjacent to each other (are not at any ortho-position). The individual anionic groups are preferably at meta-positions. An organic colorant, the anionic groups of which are located at one or more meta-positions, is small in steric hindrance between the anionic groups. For this reason, before and after the water-resisting treatment, the organic colorant is easily oriented in a linear form. Accordingly, the use of the organic colorant, the anionic groups of which are located at meta-positions, makes it possible to yield a water-resistant polarizing film high in the degree of polarization.

For example, the organic colorant is preferably an azo compound represented by the following general formula (I) or the general formula (II).

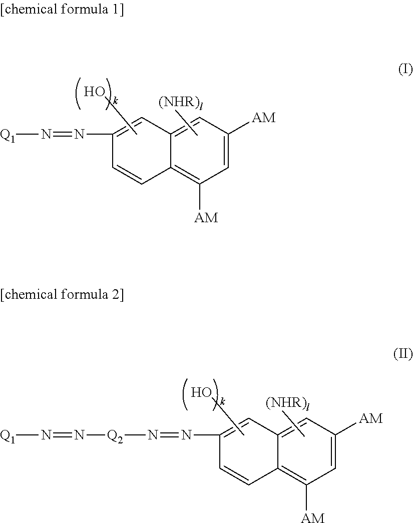

The azo compound represented by the general formula (I) or (II) has 2 or more anionic groups, and the 2 anionic groups in the naphthyl group (A in the formula) are bonded thereto at a meta-position.

In the general formulae (I) and (II), Q₁ represents a substituted or unsubstituted aryl group, Q₂ represents a substituted or unsubstituted arylene group, A represents an anionic group, M represents a counterion of the anionic group, R represents a hydrogen atom, a substituted or unsubstituted alkyl group having 1 to 3 carbon atoms, a substituted or unsubstituted acetyl group, a substituted or unsubstituted benzoyl group, or a substituted or unsubstituted phenyl group, k represents an integer of 0 to 3, and 1 represents an integer of 0 to 3. Here, k+1≦5. The wording “substituted or unsubstituted” means that a certain group is substituted with a substituent or is not substituted with any substituent.

The aryl group or arylene group represented by Q₁ or Q₂ may have a substituent or no substituent. Whether the aryl group or arylene group represented by Q₁ or Q₂ is substituted or unsubstituted, the azo compound represented by the general formula (I) or (II) exhibits absorption dichroism.

In the case where the aryl group or the arylene group has a substituent, the substituent is, for example, a halogeno group, a nitro group, a cyano group, a dihydroxy propyl group, a phenyl amino group, —OM, —COOM, —SO₃M, an alkyl group having 1 to 6 carbon atoms, an alkoxy group having 1 to 6 carbon atoms, an alkyl amino group having 1 to 6 carbon atoms, an acyl amino group having 1 to 6 carbon atoms, and the like. The substituent is preferably an anionic group such as a nitro group or a —SO₃M group. Here, M represents a counterion.

In the case where the alkyl group having 1 to 3 carbon atoms, a benzoyl group, or a phenyl group represented by R in each of the general formulae (I) and (II) has a substituent, examples of the substituent include the same substituents exemplified as substituents of the aryl group or the arylene group, as described above.

As examples of the aryl group, a condensed ring group where a benzene ring is condensed, such as a naphthyl group, can be cited, in addition to a phenyl group.

As examples of the arylene group, a condensed ring group where a benzene ring is condensed, such as a naphthylene group, can be cited, in addition to a phenylene group.

Q₁ in the general formulae (I) and (II) is preferably an optionally substituted phenyl group and more preferably a phenyl group having a substituent at a para-position.

Q₂ in the general formula (II) is preferably an optionally substituted naphthylene group and more preferably an optionally substituted 1,4-naphthylene group.

A in the general formulae (I) and (II) is, for example, a sulfonic acid group, a carboxyl group, a phosphate group, or a salt thereof. A is preferably a sulfonic acid group or a sulfonate and more preferably a sulfonate.

M in the general formulae (I) and (II) is a hydrogen atom, an alkali metal atom, an alkaline earth metal atom, a metal ion. After the polarizing film containing an azo compound represented by the general formula (I) or (II) is subjected to water-resisting treatment, M in the general formula (I) or (II) turns into a cationic specie originating from the nitrogen atom of the non-cyclic compound.

R in the general formulae (I) and (II) is preferably a hydrogen atom or a substituted or unsubstituted alkyl group having 1 to 3 carbon atoms, and more preferably a hydrogen atom.

Furthermore, k in the general formulae (I) and (II) is preferably an integer of 0 to 2 and more preferably an integer of 0 to 1. In the general formulae (I) and (II), 1 is preferably an integer of 0 to 2 and more preferably an integer of 0 to 1.

The organic colorant is preferably an azo compound represented by the following general formula (III).

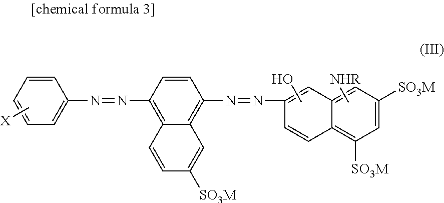

In the general formula (III), X represents a hydrogen atom, a halogen atom, a nitro group, a cyano group, a substituted or unsubstituted alkyl group having 1 to 4 carbon atoms, a substituted or unsubstituted alkoxy group having 1 to 4 carbon atoms, or a —SO₃M group.

R and M in the general formula (III) are identical with R and M in the general formula (I), respectively.

In the case where the alkyl group having 1 to 4 carbon atoms or the alkoxy group having 1 to 4 carbon atoms represented by X in the general formula (III) has a substituent, examples of the sub stituent include the same sub stituents exemplified as substituents of the aryl group or the arylene group.

X in the general formula (III) is preferably a hydrogen atom, a nitro group, or a cyano group, and more preferably a nitro group.

The organic colorant, such as the azo compound, exhibits liquid crystallinity (lyotropic liquid crystallinity) in the state that the colorant is dissolved in a solvent. Specifically, when the organic colorant, such as the azo compound, is dissolved in a solvent, the colorant forms a supermolecular association. When a liquid containing this organic colorant is cast into a predetermined direction, shearing force is applied to the supermolecular association. As a result, a coating film can be formed wherein the long axis of the supermolecular association is oriented in the flow direction. In the resultant coating film, the organic colorant is oriented in the predetermined direction. Therefore, the film exhibits good absorption dichroism.

In particular, in the azo compound represented by the general formula (III), the 2 or more —SO₃M groups are not adjacent to each other, so that in the azo compound, —SO₃M groups are small in steric hindrance; therefore, before or after the water-resisting treatment, the azo compound is linearly oriented, whereby a water-resistant polarizing film high in the degree of polarization can be obtained.

The azo compounds represented by the general formulae (I) to (III) can each be obtained by, for example, the following method: an aniline derivative and a naphthalenesulfonic acid derivative are caused to undergo diazotization and coupling reaction in a usual manner to yield a monoazo compound; this monoazo compound is diazotized; and then the resultant is caused to undergo coupling reaction with an aminonaphtholdisulfonic acid derivative.

### (Non-Cyclic Compound Having 2 to 5 Nitrogen Atoms)

The non-cyclic compound contained in the water-resistant polarizing film has 2 to 5 nitrogen atoms.

The water-resistant polarizing film containing the organic colorant and the non-cyclic compound is excellent in mechanical strength and optical properties.

The reason why the water-resistant polarizing film of the present invention is excellent in mechanical strength and optical properties is inferred as follows:

In general, the molecular structure of the organic colorant is a slender or flat form. This organic colorant has a nature that the colorant is oriented in substantially the same direction as adjacent organic colorants in the state that a predetermined interval is placed between the colorants. When this oriented organic colorant is fixed, a polarizing film is obtained. Furthermore, when a crosslinking agent is bonded to anionic groups (such as —SO₃M groups) of the oriented organic colorants to form a large organic colorant molecule, a polarizing film excellent in water resistance (water-resistant polarizing film) is obtained.

If a cyclic compound is used as the crosslinking agent, the intervals between the organic colorants are disturbed (in other words, the orientation of the organic colorants is disturbed) so that optical properties of the polarizing film are declined. Furthermore, the cyclic compound is bulky and rigid so that the mechanical strength of the polarizing film is also lowered.

By contrast, when a non-cyclic compound is used as the crosslinking agent as in the present invention, the intervals between the organic colorants are not easily disturbed so that the mechanical strength of the polarizing film is not easily lowered. Furthermore, the non-cyclic compound is softer than cyclic compounds; thus, the mechanical strength of the polarizing film is not easily declined, either.

Even when the crosslinking agent is a non-cyclic compound, only a single crosslinking point is generated between the compound and the anionic group in the organic colorant if the non-cyclic compound has only one nitrogen atom. For this reason, adjacent organic colorants cannot be crosslinked (intermolecularly-crosslinked) with each other so that a polarizing film excellent in water resistance cannot be yielded.

Furthermore, even when the crosslinking agent is a non-cyclic compound, complicated crosslinking points are generated between the compound and the anionic group of the organic colorant if the non-cyclic compound has a large number (for example, several tens to several hundreds) of nitrogen atoms. For this reason, the orientation of the organic colorant is disturbed so that optical properties of the polarizing film are declined.

By contrast, when a non-cyclic compound having 2 to 5 nitrogen atoms is used as the crosslinking agent as in the present invention, adjacent organic colorants can be crosslinked with each other through appropriate crosslinking points. Therefore, a polarizing film excellent in water resistance can be obtained without disturbing the orientation of the organic colorant.

As described above, when a non-cyclic compound has 2 to 5 nitrogen atoms, the number of the crosslinking points between the compound and the organic colorant does not become excessively large so that adjacent organic colorants can be crosslinked with each other.

However, in order to yield a water-resistant polarizing film particularly excellent in optical properties, it is preferable to crosslink the adjacent organic colorants with each other through crosslinking points the number of which is relatively small.

Therefore, the non-cyclic compound used in the present invention is preferably a compound having 2 or 3 nitrogen atoms and particularly preferably a compound having 2 nitrogen atoms.

The non-cyclic compound having 2 to 5 nitrogen atoms may be linear or branched, and is preferably linear. When the linear non-cyclic compound is used, a water-resistant polarizing film more excellent in mechanical strength can be obtained.

The nitrogen atom is preferably contained in a cationic group bonded to the non-cyclic compound. Examples of the cationic group include an amino group, a guanidino group, an imino group, an ammonium group, a salt thereof, and the like.

Examples of the salt include inorganic acid salts such as a hydrochloride, a hydrosulfate, a phosphate, and the like; organic acid salts such as acetic acid, formic acid, and oxalic acid, and the like.

Among them, the cationic group is preferably an amino group or a salt thereof.

The non-cyclic compound is preferably a compound having 2 to 5 cationic groups which contain the nitrogen atom, more preferably a compound having 2 or 3 cationic groups, and further preferably a compound having 2 cationic groups.

The non-cyclic compound is preferably a compound having a main chain both the ends of which are each terminated with a bonded cationic group.

Examples of the non-cyclic compound having 2 to 5 nitrogen atoms include aliphatic diamines such as an alkyl diamine or salts thereof; aliphatic triamines such as an alkyl triamine or salts thereof aliphatic tetraamines such as an alkyl tetraamine or salts thereof; aliphatic pentaamines such as an alkyl pentaamine or salts thereof; aliphatic ether diamines such as an alkyl ether diamine or salts thereof; and the like.

As the non-cyclic compound, an aliphatic diamines or salts thereof having 2 to 8 carbon atoms or/and an aliphatic ether diamines or salts thereof having 2 to 8 carbon atoms is(are) preferably used.

Examples of the linear aliphatic diamine include ethylenediamine, 1,3-propanediamine, 1,4-butanediamine, 1,5-pentanediamine, 1,6-hexanediamine, 1,7-heptanediamine, 1,8-octanediamine, 1,9-nonanediamine, 1,10-decanediamine, 1,11-undecanediamine, 1,12-dodecanediamine, and the like. Among them, linear alkyldiamines having 2 to 8 carbon atoms such as 1,3-propanediamine, 1,4-butanediamine, 1,5-pentanediamine, 1,6-hexanediamine, 1,7-heptanediamine, and the like are preferably used.

Examples of the branched aliphatic diamine include 1-butyl-1,2-ethanediamine, 1,1-dimethyl-1,4-butanediamine, 1-ethyl-1,4-butanediamine, 1,2-dimethyl-1,4-butanediamine, 1,3-dimethyl-1,4-butanediamine, 1,4-dimethyl-1,4-butanediamine, 2,3-dimethyl-1,4-butanediamine, 2-methyl-1,5-pentanediamine, 3-methyl-1,5-pentanediamine, and the like.

Examples of the aliphatic triamine include diethylenetriamine, dipropylenetriamine, 1,2,4-butanetriamine, 1,2,5-pentanetriamine, 1,3,5-pentanetriamine, 1,2,6-hexanetriamine, 1,4,7-heptanetriamine, and the like.

Examples of the aliphatic tetraamine include triethylenetetramine, tetraethylenetetramine, and the like.

Examples of the aliphatic pentamine include tetraethylenepentamine and the like.

Examples of the linear aliphatic ether diamine having 2 to 8 carbon atoms include 2,2′-oxybis(ethylamine), 3,3′-oxybis(propylamine), 1,2-bis(2-aminoethoxy)ethane, and the like.

The concentration of the organic colorant in the water-resistant polarizing film of the present invention is preferably 80% by mass or more and less than 100% by mass and more preferably 90% by mass or more and less than 100% by mass with respect to total mass of the polarizing film.

The concentration of the non-cyclic compound in the water-resistant polarizing film of the present invention is preferably more than 0 and 20% by mass or less and more preferably 1 to 10% by mass with respect to total mass of the polarizing film.

The water-resistant polarizing film may contain other component different from the organic colorant and the non-cyclic compound as far as the advantageous effects of the present invention are not damaged.

Examples of the other component include other organic colorant (an organic colorant other than an organic colorant having an anionic group), a various additive, an optionally polymer, and the like.

### (Properties of Water-Resistant Polarizing Film)

The water-resistant polarizing film of the present invention exhibits absorptive dichroism at least at partial wavelengths in the visible ray range (wavelengths: 380 to 780 nm).

The transmittance of the water-resistant polarizing film is 38% or more, preferably 39% or more, and more preferably 40% or more.

The degree of polarization (a degree of polarization calculated from Y values subjected to vision sensitivity correction) is 98% or more and preferably 99% or more.

The thickness of the water-resistant polarizing film is not particularly limited, but preferably 0.1 to 10 μm. When the thickness of the water-resistant polarizing film is less than 1 μm, the film may be used in the state of being laminated on a substrate in order to cause the film to keep self-standing performance certainly.

### [Process for Producing Water-Resistant Polarizing Film]

The water-resistant polarizing film of the present invention can be produced through, for example, the following steps A to C; and after the step C, the following step D may be performed:

step A: a step of forming a coating film containing an organic colorant by applying a coating liquid containing the organic colorant having an anionic group on a substrate.

step B: a step of yielding a polarizing film by drying the coating film formed in the step A.

step C: a step of bringing a single surface or both surfaces of the polarizing film yielded in the step B into contact with a treating liquid, which contains a non-cyclic compound having 2 to 5 nitrogen atoms (water-resistant treatment).

step D: a step of causing the polarizing film to undergo washing and/or some other treatment in order to remove an excess of the treating liquid, which adheres onto the polarizing film.

### (Step A)

In the step A, a coating liquid containing an organic colorant is applied on a substrate to form a coating film.

Examples of the organic colorant include the colorants as exemplified above, and the azo compound represented by the general formula (III) is preferably used. The coating liquid can be prepared by dissolving the organic colorant in an appropriate solvent. The organic colorants in the coating liquid form supermolecules in the liquid. As a result, the coating liquid exhibits a liquid crystal phase. The liquid crystal phase is not particularly limited, and examples of the liquid crystal phase include a nematic liquid crystal phase, a smectic liquid crystal phase, a cholesteric liquid crystal phase, a hexagonal liquid crystal phase, and the like. The liquid crystal phase can be identified and confirmed from an optical pattern when observed by using a polarization microscope.

The solvent is not particularly limited and a conventionally known one can be used. The solvent which can dissolve the organic colorant satisfactorily is preferably used. By the use of the coating liquid wherein the organic colorant is satisfactorily dissolved, the organic colorant does not precipitate easily when the coating liquid is applied onto the substrate to form a film. Accordingly, a polarizing film excellent in transmittance can be obtained.

For example, the solvent, which can dissolve the organic colorant satisfactorily, is for example, an aqueous solvent. Examples of the aqueous solvent include water, a hydrophilic solvent, and a mixed solvent containing water and the hydrophilic solvent. The hydrophilic solvent is a solvent, which can be dissolved with water uniformly. Examples of the hydrophilic solvent include, for example, alcohols such as methanol, ethanol, methyl alcohol, isopropyl alcohol, and the like; glycols such as ethylene glycol, diethylene glycol, and the like; cellosolves such as methyl cellosolve, ethyl cellosolve, and the like; ketones such as acetone, methyl ethyl ketone, and the like; esters such as acetic ether and the like. Preferably, the solvent is water or the mixed solvent containing water and the hydrophilic solvent.

The concentration of the organic colorant in the coating liquid is preferably prepared so as to exhibit a liquid crystal phase. Specifically, the concentration of the organic colorant is preferably 0.5 to 50% by mass. In the partial range of this concentration, the coating liquid may exhibit a liquid crystal phase.

In addition, the pH of the coating liquid is preferably prepared about pH 4 to 10 and more preferably about pH 6 to 8.

Further, an additive may be added to the coating liquid. Examples of the additive include, for example, a plasticizer, a heat stabilizer, a light stabilizer, a lubricant, an antioxidant, an ultraviolet absorber, a flame retardant, a coloring agent, an antistatic agent, an antifungus agent, a compatibilizing agent, a cross-linking agent, a thickening agent, and the like. The concentration of the additive in the coating liquid is preferably more than 0 and 10% by mass or less. A surfactant may be added to the coating liquid. The surfactant is used for improving the wettability and the application property of the coating liquid onto a surface of a substrate. As the surfactant, a nonionic surfactant is preferably used. The concentration of the surfactant in the coating liquid is preferably more than 0 and 5% by mass or less.

The method for preparing the coating liquid is not particularly limited, and the organic colorant may be added in a container containing the solvent, or the solvent may be added in a container containing the organic colorant, for example.

The coating film may be formed by applying the coating liquid on an appropriate substrate. The substrate is used for uniformly developing of the coating liquid. The type of the substrate is not particularly limited as far as it is proper to the object. Examples of the substrate include a polymer film (the term “film” includes those generally referred to as sheets), a glass plate, and the like. In a preferable embodiment, a single polymer film is used as the substrate. In other preferable embodiment, a laminated body containing a polymer film is used as the substrate. The laminate more preferably contains an orientation layer in addition to the polymer film.

The polymer film is not particularly limited, but preferably a film excellent in transparency (for example, having a haze value of 5% or less).

The thickness of the substrate can be suitably designed in accordance with the strength and the like. However, in terms of thickness reduction and weight reduction, the thickness of the substrate is preferably 300 μm or less, more preferably 5 to 200 μm, and particularly preferably 10 to 100 μm.

In the case where the substrate has an orientation layer, this orientation layer may be formed by subjecting an orientation treatment to a surface of the substrate. Examples of the orientation treatment include a mechanical orientation treatment such as a rubbing treatment, a chemical orientation treatment such as an optical orientation treatment, and the like.

The coating liquid is applied on the substrate (preferably on the orientation layer of the substrate). The viscosity of the coating liquid, when the coating liquid is applied, is preferably 0.1 to 30 mPa·s and more preferably 0.5 to 3 mPa·s. Here, the viscosity is a value measured by a rheometer (manufactured by Haake Co., Ltd., product name: RHEOSTRESS 600, measuring condition: double cone sensor shear rate 1000(1/s)).

In the case where hydrophilicity of an applying surface (a surface where the coating liquid is applied) is low, a hydrophilization treatment is preferably subjected to the applying surface.

The hydrophilization treatment may be a dry treatment or a wet treatment. Examples of the dry treatment include discharge treatments such as a corona treatment, a plasma treatment, a glow discharge treatment, and the like; a flame treatment; an ozone treatment; an UV ozone treatment; and ionization active ray treatments such as an ultraviolet treatment, an election beam treatment, and the like. Examples of the wet treatment include an ultrasonic treatment using a solvent such as water or acetone, an alkali treatment, or an anchor coat treatment. These treatments may be conducted alone or in combination of two or more thereof.

For example, as an applying method of the coating liquid, an applying method using a suitable coater may be adopted. Examples of the coater include a bar coater, a reverse roll coater, a positive rotation roll coater, a gravure coater, a rod coater, a slot die coater, a slot orifice coater, a curtain coater, a fountain coater, and the like.

When the coating liquid in such a state as to exhibit a liquid crystal phase is coated, shearing stress is applied to the organic colorant in a process where the coating liquid flows. As a result, a coating film where the organic colorant is oriented in a predetermined direction may be formed.

The organic colorant aligns by the shearing stress applied to the coating liquid when it flows. In addition to or alternative to this method, the organic colorant may be oriented by other method.

Examples of the other method include a method of applying the coating liquid on a substrate which is subjected to an orientation treatment, a method of applying a magnetic field or an electrical field after the formation of a coating film by applying the coating liquid on a substrate, and the like. If these other methods are conducted singly, the coating film wherein the organic colorant is oriented in a predetermined direction may be formed.

### (Step B)

The step B is a step of drying the coating film formed in the step A.

The method for drying the coating film may be natural drying, forcible drying, and the like. The forcible drying includes, for example, drying means such as an air-circulation type thermostatic oven by which hot air or cool air circulates, a heater using a microwave, a far infrared ray, or the like, a roll heated for temperature adjustment, a heat pipe roll, or a metal belt. The drying temperature is below or equal to the isotropic phase transition temperature of the coating liquid, and it is preferable to dry the coating film by gradually raising the temperature from low temperature to high temperature. Specifically, the drying temperature is preferably 10 to 80° C. and more preferably 20 to 60° C. Within such a temperature range, a dried coating film having small thickness variation can be obtained.

The drying time can be suitably selected in accordance with the drying temperature and the kind of the solvent. In order to obtain a dried coating film which has small thickness variation, the drying time is 1 to 30 minutes and more preferably 1 to 10 minutes, for example.

The coating film will have a higher concentration in the drying process and the oriented organic colorant will be fixed. An absorption dichroism is generated by fixing the orientation of the organic colorant. The dried coating film is a polarizing film.

The thickness of the obtained polarizing film (the dried coating film) is preferably 0.1 to 10 μm. The residual solvent amount of the polarizing film is preferably 1% by mass or less and more preferably 0.5% by mass or less.

### (Step C)

The step C is a step of bringing a treating liquid containing a non-cyclic compound having 2 to 5 nitrogen atoms into contact with a surface (the surface opposite to the bonded surface of the substrate) of the polarizing film obtained in the step B.

The non-cyclic compound contained in the treating liquid is the non-cyclic compound as exemplified above and preferably a linear alkyldiamine having 2 to 8 carbon atoms.

The treating liquid is obtained by dissolving or dispersing the non-cyclic compound in a solvent. The solvent is preferably an aqueous solvent. Usable examples of the aqueous solvent are the same as the examples in the description column of the coating liquid.

The concentration of the non-cyclic compound in the treating liquid is preferably 5 to 30% by mass and more preferably 10 to 20% by mass. By use of the treating liquid, water resistance is given to the polarizing film obtained in the step B without deterioration of mechanical strength and optical properties thereof.

The treating liquid is brought into contact with a single surface or both surfaces of the polarizing film obtained in the step B, thereby making it possible to obtain a water-resistant polarizing film excellent in mechanical strength and optical properties. The method for bringing the treating liquid into contact with the polarizing film is not particularly limited. Examples of the contacting method include a method of applying the treating liquid onto the surface of the polarizing film and a method of immersing the polarizing film into the treating liquid. The applying of the treating liquid can be conducted by use of a spray, a various coater, or the like. If these methods are adopted, the surface of the polarizing film is preferably washed with water or an optionally solvent and dried.

The method for the contacting is preferably a method of immersing the polarizing film into the treating liquid. According to this method, the treating liquid can be surely brought into contact with the whole of the polarizing film. Additionally, according to this method, the treating liquid penetrates easily into the polarizing film; thus, the organic colorant and the non-cyclic compound can be crosslinked with each other in a large quantity. For this reason, water resistance can be surely given to the polarizing film.

### (Step D)

In the step D, the surfaces of the polarizing film subjected to the water-resisting treatment are washed and/or dried.

The step D is performed to remove an excess of the treating liquid that is adhered to the water-resistant polarizing film yielded in the step C. For example, the polarizing film subjected to the water-resisting treatment may be washed with water and then dried. Alternatively, the polarizing film subjected to the water-resisting treatment may be simply dried.

The process for producing the present invention may have any step other than the steps A to D.

### [Use of Water-Resistant Polarizing Film]

For example, the water-resistant polarizing film of the present invention may be used as a polarizing plate by laminating a protective film on one surface or both surfaces thereof. In the case where the water-resistant polarizing film is used as the polarizing plate, a birefringent film may be further laminated thereon.

The water-resistant polarizing film obtained by the process for producing the present invention may be used in the state that the water-resistant polarizing film is laminated on the substrate, or in the state that the water-resistant polarizing film is peeled off from the substrate. In the case where the water-resistant polarizing film is used in the state that the water-resistant polarizing film is laminated on the substrate, the substrate may be used as a protective film.

The water-resistant polarizing film of the present invention is preferably mounted on an image display device.

Examples of the image display device having the water-resistant polarizing film of the present invention include a liquid crystal display device, an organic EL display, a plasma display, and the like. The preferable use of the image display device is a TV set.

### EXAMPLES

The present invention will be described in detail by way of Examples and Comparative Examples. The invention is not limited only to the following Examples. Each of measuring methods used in the Examples and the Comparative Examples is as follows:

### [Observation Method of Liquid Crystal Phase]

A small amount of a coating liquid was sandwiched between two glass slides and observed a liquid crystal phase by using a polarization microscope (product name: “OPTIPHOT-POL,” manufactured by Olympus Corporation).

### [Measurement of Thickness of Polarizing Film]

A portion of the polarizing film was peeled off from a polymer film and a step between the polymer film and the polarizing film was measured by using a three-dimensional non-contact surface form measuring system (product name: “Micromap MM5200,” manufactured by Ryoka Systems Inc.).

### [Method for Evaluating Water Resistance of Polarizing Film]

When any polarizing film was immersed in a treating liquid, it was observed with the naked eye whether or not the polarizing film was dissolved therein. When the polarizing film was not dissolved, the film was evaluated as a “water-resistant” film. When the polarizing film was dissolved, the film was evaluated as a “non-water-resistant” film.

### [Method for Checking Crack in Polarizing Film]

Any polarizing film subjected to water-resisting treatment was put onto an observing stage of a polarizing microscope (product name: “OPTIPHOT-POL”, manufactured by Olympus Corp.) and was observed with a magnification of 100 to check whether or not the film was cracked.

### [Method for Measuring Transmittance and Degree of Polarization of Polarizing Film]

A spectrophotometer (product name: “U-4100”, manufactured by JASCO Corp.) equipped with a Glan-Thompson polarizer was used, and linearly polarized light having a wavelength of 380 to 780 nm was radiated into any polarizing film. A multiplication of a luminous correction factor was made at each of the wavelengths and then the resultant values were integrated to measure the average values k₁ and k₂, respectively, in the wavelength region. The values k₁ and k₂ are substituted for the following equations 1 and 2, thereby calculating the transmittance and the degree of polarization:

the single transmittance k=(k₁+k₂)/2 (1)

the degree of polarization=(k₁−k₂)/(k₁+k₂) (2)

In the equations 1 and 2, k₁ represents the transmittance of the linearly polarized light in the maximum transmittance direction, and k₂ represents the transmittance of the linearly polarized light in the direction perpendicular to the maximum transmittance direction.

### Example 1

4-nitroaniline and 8-amino-2-naphthalenesulfonic acid were caused to undergo diazotization and coupling reaction by a usual method (a method described on pages 135 to 152 of “Riron Seizoh, Senryo Kagaku (Theory Production, Dye Chemistry), 5^{th} edition” written by Yutaka Hosoda, and published by Gihodo Shuppan Co., Ltd. on Jul. 15, 1968) to yield a monoazo compound. The resultant monoazo compound was diazotized by the usual method, and further the resultant was subjected to coupling reaction with lithium 1-amino-8-naphthol-2,4-disulfonate, thereby yielding a crude product. This was salted out with lithium chloride to yield an azo compound having the following structural formula (IV):

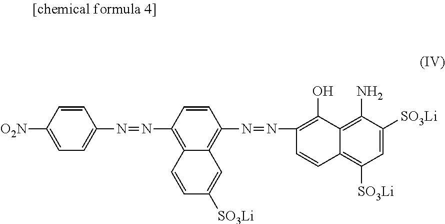

The azo compound of the formula (IV) was dissolved in ion exchange water to prepare a 20% by mass of coating liquid thereof. This coating liquid was observed at room temperature (23° C.) by the above-mentioned method for observing a liquid crystal phase. As a result, the coating liquid exhibited a nematic liquid crystal phase.

A bar coater (product name: “Mayer rot HS4”, manufactured by Bushman Co.) was used to apply the coating liquid onto a norbornene-based polymer film (trade name: “ZEONOR”, manufactured by Nippon Zeon Co., Ltd.) subjected to rubbing treatment and corona treatment, and the resultant was naturally dried sufficiently in a thermostat of 23° C. The thickness of the resultant polarizing film was 0.4 μm.

In order to subject the polarizing film to water-resisting treatment, the film was immersed in an aqueous solution containing 1,4-butanediamine hydrochloride (manufactured by Tokyo Chemical Industry Co., Ltd.) (concentration: 10% by mass) for 1 minute. Next, this polarizing film was washed with water, and then dried to produce a water-resistant polarizing film. The individual measurement results of the water-resistant polarizing film of Example 1 are shown in Table 1.

The Reference Example in Table 1 is concerned with the transmittance and the degree of polarization of the polarizing film before the film was subjected to the water-resisting treatment in Example 1 (the polarizing film of Example 1 without being subjected to the water-resisting treatment).

### Example 2

A water-resistant polarizing film was produced in the same way as in Example 1 except that 1,4-butanediamine hydrochloride was changed to 1,6-hexanediamine hydrochloride (manufactured by Tokyo Chemical Industry Co., Ltd.). The individual measurement results of the water-resistant polarizing film of Example 2 are shown in Table 1.

### Example 3

A water-resistant polarizing film was produced in the same way as in Example 1 except that 1,4-butanediamine hydrochloride was changed to 2,2′-oxybisethyl hydrochloride (manufactured by Tokyo Chemical Industry Co., Ltd.). The individual measurement results of the water-resistant polarizing film of Example 3 are shown in Table 1.

### Comparative Example 1

A water-resistant polarizing film was produced in the same way as in Example 1 except that 1,4-butanediamine hydrochloride was changed to piperazine (manufactured by Tokyo Chemical Industry Co., Ltd.). The individual measurement results of the water-resistant polarizing film of Comparative Example 1 are shown in Table 1.

### Comparative Example 2

A water-resistant polarizing film was produced in the same way as in Example 1 except that 1,4-butanediamine hydrochloride was changed to 1,2-cyclohexanediamine (manufactured by Tokyo Chemical Industry Co., Ltd.). The individual measurement results of the water-resistant polarizing film of Comparative Example 2 are shown in Table 1.

### Comparative Example 3

A water-resistant polarizing film was produced in the same way as in Example 1 except that 1,4-butanediamine hydrochloride was changed to polyethylenimine (trade name: “EPOMIN SP-200”, manufactured by Nippon Shokubai Co., Ltd., weight-average molecular weight: 10,000, deduced number of nitrogen atoms: about 250). The individual measurement results of the water-resistant polarizing film of Comparative Example 3 are shown in Table 1.

### Comparative Example 4

A water-resistant polarizing film was produced in the same way as in Example 1 except that 1,4-butanediamine hydrochloride was changed to triethylamine (manufactured by Tokyo Chemical Industry Co., Ltd.). The individual measurement results of the water-resistant polarizing film of Comparative Example 4 are shown in Table 1.

When the polarizing film of Comparative Example 4 was immersed in the treating liquid containing triethylamine, the film was dissolved therein. Thus, the film had no water resistance. Moreover, about the polarizing film of Comparative Example 4, the check of a crack, and the measurement of the transmittance and the degree of polarization were unable to be made since the film was dissolved as described above.

Structural formulae of 1,4-butanediamine hydrochloride etc. used in the Examples and the Comparative Examples are shown in below.

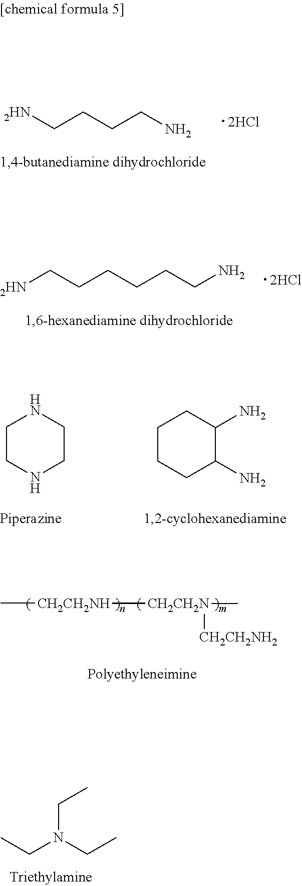

TABLE 1

| | compound used for | | | | | |
|---|---|---|---|---|---|---|
| | water-resistant treatment | | measured results of water-resistant polarizing film | | | |
| | | number of | water | | Transmittance | degree of |
| | structure | nitrogen atoms | resistance | crack | (%) | polarization (%) |
| Example 1 | non-cyclic | 2 | water | not cracked | 40 | 99 |
| | | | resistance | | | |
| Example 2 | non-cyclic | 2 | water | not cracked | 40 | 99 |
| | | | resistance | | | |
| Example 3 | non-cyclic | 2 | water | not cracked | 40 | 99 |
| | | | resistance | | | |
| Comparative | cyclic | 2 | water | cracked | 37 | 98 |
| Example 1 | | | resistance | | | |
| Comparative | cyclic | 2 | water | cracked | 37 | 96 |
| Example 2 | | | resistance | | | |
| Comparative | non-cyclic | 250 | water | not cracked | 36 | 98 |
| Example 3 | | | resistance | | | |
| Comparative | non-cyclic | 1 | no-water | — | — | — |
| Example 4 | | | resistance | | | |
| Reference | — | — | — | — | 40 | 99 |
| Example | | | | | | |

### [Evaluation]

Examples 1 to 3, wherein the non-cyclic compound was used, were not cracked, and were further excellent in transmittance and the degree of polarization. By contrast, Comparative Examples 1 and 2, wherein the cyclic compound was used, were cracked and were poor in mechanical strength.

Comparative Example 3, wherein a non-cyclic compound was used but the compound was a non-cyclic compound having 250 nitrogen atoms, was poor in transmittance and the degree of polarization. Comparative Example 4, wherein a non-cyclic compound was used but the compound was a non-cyclic compound having one nitrogen atom, had no water resistance.

The transmittance and the degree of polarization of each of Examples 1 to 3 were equal to those of the Reference Example. From this matter, it is understood that even when water-resisting treatment using a non-cyclic compound is conducted, the treatment does not produce any effect onto the transmittance and the degree of polarization.

### [Endurance Test]

Each of the water-resistant polarizing films of Examples 1 to 3 was allowed to stand in a thermostat of 60° C. and 90% in relative humidity for 500 hours. According to the above-mentioned measuring method, the degree of polarization of the water-resistant polarizing film after the standing was measured. As a result, the reduction ratio in the degree of polarization of each of the water-resistant polarizing films of Examples 1 to 3 was less than 5%. In light of this matter, the water-resistant polarizing films of Examples 1 to 3 were also excellent in endurance.

The reduction ratio in the degree of polarization={(the degree of polarization of the polarizing film immediately after production−that of the polarizing film after standing for 500 hours)/that of the polarizing film immediately after production}×100.

The water-resistant polarizing film of the present invention can be used in an image display device such as a liquid crystal display, polarizing sunglasses, and the like.

The process for producing the present invention can be appropriately used when a water-resistant polarizing film which is not easily corroded with water is produced.

1. A water-resistant polarizing film, comprising an organic colorant having an anionic group, and a non-cyclic compound having 2 to 5 nitrogen atoms.

2. The water-resistant polarizing film according to claim 1, wherein the non-cyclic compound has 2 nitrogen atoms.

3. The water-resistant polarizing film according to claim 1, wherein the non-cyclic compound has 2 to 5 cationic groups each containing a nitrogen atom.

4. The water-resistant polarizing film according to claim 3, wherein the cationic groups are each an amino group or a salt thereof.

5. The water-resistant polarizing film according to claim 1, wherein the non-cyclic compound is a linear aliphatic diamine or a salt thereof, or a linear aliphatic ether diamine or a salt thereof.

6. The water-resistant polarizing film according to claim 1, wherein the non-cyclic compound is an aliphatic diamine having 2 to 8 carbon atoms or a salt thereof, or an aliphatic ether diamine having 2 to 8 carbon atoms or a salt thereof.

7. The water-resistant polarizing film according to claim 1, wherein the organic colorant has 2 or more anionic groups.

8. A process for producing a water-resistant polarizing film, comprising a step of bringing a treating liquid containing a non-cyclic compound having 2 to 5 nitrogen atoms into contact with a single surface or both surfaces of a polarizing film containing an organic colorant having an anionic group.

9. The process for producing a water-resistant polarizing film according to claim 8, wherein the concentration of the non-cyclic compound in the treating liquid is 5 to 30% by mass.

10. An image display device, comprising the water-resistant polarizing film as recited in claim 1.
